(19) United States
(12) Patent Application Publication
(10) Pub. No.: US 2016/0183593 A1
(43) Pub. Date: Jun. 30, 2016

(54) ELECTRONIC CIGARETTE

(71) Applicant: KIMREE HI-TECH INC., Tortola (VG)

(72) Inventor: Qiuming Liu, Shenzhen, Guangdong (CN)

(73) Assignees: KIMREE HI-TECH INC., Tortola (VG); KIMREE HI-TECH INC., Tortola (VG)

(21) Appl. No.: 14/909,458

(22) PCT Filed: Aug. 1, 2013
(86) PCT No.: PCT/CN2013/080627

§ 371 Date: Feb. 1, 2016

(51) Int. Cl. A24F 47/00; H05B 3/06; H05B 3/03

(52) U.S. Cl. CPC A24F 47/008; H05B 3/03; H05B 3/06

(57) ABSTRACT

An electronic cigarette comprises an atomizer (1) and a battery rod (2). A connecting structure is provided at where the atomizer (3) and the battery rod (2) are connected. The connecting structure comprises a first connecting element (3) and a second connecting element (4) that are docked with each other. The first connecting element (3) is provided with a docking groove (31) used for insertion of the second connecting element (4). An engaging part is provided within the docking groove (31). An engaging-retaining notch extended to an end face of the second connecting element (4) is provided at an outer-side extremity of the second connecting element (4) in proximity to the first connecting element (3). When engaging, the engaging part is inserted along the engaging-retaining notch and is rotated and engaged on the engaging notch.

### FIELD OF THE INVENTION

The present invention relates to the field of electric heating products, and more particularly relates to an electronic cigarette.

### BACKGROUND OF THE INVENTION

Generally, an electronic cigarette comprises an atomizer and a battery rod. In the electronic cigarette of the prior art, the connection between the atomizer assembly and the battery assembly is mainly threaded connection or direct insertion connection. Since the threaded connection is of easy malposition, low reliability and inconvenient disassembly and the direct insertion connection exists the drawback of weak connection, the electronic cigarette in the prior art is inconvenient to use, is against to give up smoking, and provides bad user's experience.

### SUMMARY OF THE INVENTION

The objective of the present invention is to provide an electronic cigarette with easy assembly and strong connection, aiming at the defect that the connection between the atomizer and the battery rod of the electronic cigarettes in the prior art is of complicate operation and weak connection.

The technical solutions of the present invention for solving the technical problems are as follows:

An electronic cigarette is provided, which comprises an atomizer and a battery rod; a connecting structure is defined at where the atomizer and the battery rod are connected, and the connecting structure comprises a first connecting element and a second connecting element that are docked with each other; the first connecting element is provided with a docking groove used for insertion of the second connecting element; an engaging part is provided within the docking groove; an engaging-retaining notch extended to an end surface of the second connecting element is provided at one end of the second connecting element, the end is in proximity to the first connecting element; when engaged, the engaging part is inserted along the engaging-retaining notch and is rotated and hence engaged on the engaging-retaining notch.

The engaging-retaining notch comprises a first notch circumferentially defined on the second connecting element, and a second notch axially extended from one end of the first notch and open to the first connecting element; when engaged, the engaging part is inserted into the second connecting element along the second notch, and is rotated along the first notch to realize fixing connection between the engaging part and the second connecting element.

The second connecting element comprises a first external electrode defined at an outside of the second connecting element; and the first and second notches and are defined on the first external electrode.

A second external electrode that is hollow is defined on the first connecting element; and the engaging part is a protrusion radially extended from an inner wall of the second external electrode along a direction toward a central axis of the second external electrode.

A second external electrode that is hollow is defined on the first connecting element; a through hole for passing of a pin is defined in a side wall of the second external electrode; and the pin is inserted into the through hole via interference fit and is protruded toward a central axis of the second external electrode to form the engaging part.

The first external electrode is sheathed in the second external electrode, and an outer wall of the first external electrode and an inner wall of the second external electrode are fitted each other well.

A first internal electrode and an insulating ring are further sheathed in the second external electrode, and the insulating ring is arranged between the second external electrode and the first internal electrode.

A third external electrode is defined on the first connecting element, and a bracket is defined at one side of the third external electrode away from the second connecting element.

The first external electrode and the third external electrode are both cylindrical shaped; when engaged, the first external electrode is sheathed in the third external electrode, and an outer wall of the first external electrode and an inner wall of the third external electrode are fitted each other well.

The bracket comprises a bracket body and a connecting portion extended from the bracket body toward the second connecting element; a side surface of an end portion of the connecting portion is circumferentially extended to form a convex portion coaxially arranged with the first notch and shaped to fit the first notch; and the engaging part is the convex portion.

The bracket is an insulator, a second internal electrode is sheathed in the third external electrode, and the second internal electrode is inserted into the bracket via interference fit.

The bracket is any one selected from the group consisting of rigid silicone element, rubber element and resin element.

The shape of the connecting portion is adapted to the shape of the second notch.

The first connecting element is defined on the atomizer or the battery rod, and the second connecting element is defined on the battery rod or the atomizer.

The first and the second notches and together form an L-shaped structure.

The first and the second notches and together form a T-shaped structure.

When implementing the electronic cigarette of the present invention, the following advantageous effects can be achieved:

By connecting the battery rod with the atomizer by means of rotating engagement, the user can quickly assembly the battery rod with the atomizer and it facilitates the replacement of the atomizer when the tobacco liquid in the atomizer is run out. Meanwhile, by arranging the engaging-retaining notch at the outside of the second connecting element and arranging the engaging part within the first connecting element, it facilitates manufacture, the production efficiency will be improved, and it facilitates modification to the shape of the engaging-retaining notch to adapt to other shape of the engaging part.

### BRIEF DESCRIPTION OF THE DRAWINGS

The present invention will be further described with reference to the accompanying drawings and embodiments in the following, in the accompanying drawings:

FIG. 1 is an exploded structural view of an atomizer and a battery rod of an electronic cigarette according to a first embodiment of the present invention;

FIG. 2 is a partially cut-way view of the electronic cigarette according to the first embodiment of the present invention;

FIG. 3 is an exploded structural view of an atomizer and a battery rod of an electronic cigarette according to a second embodiment of the present invention;

FIG. 4 is a partially cut-way view of the electronic cigarette according to the second embodiment of the present invention;

FIG. 5 is a 3D view of a first external electrode and a bracket connecting structure viewing from a viewpoint according to a second embodiment of the present invention;

FIG. 6 is a 3D view of the first external electrode and the bracket connecting structure viewing from another viewpoint according to a second embodiment of the present invention.

### DETAILED DESCRIPTION OF THE PREFERRED EMBODIMENT

In order to make a clear understand to the technical features, objectives and effects of the present invention, the specific embodiments of the present invention will be described in detail with reference to the accompanying drawings.

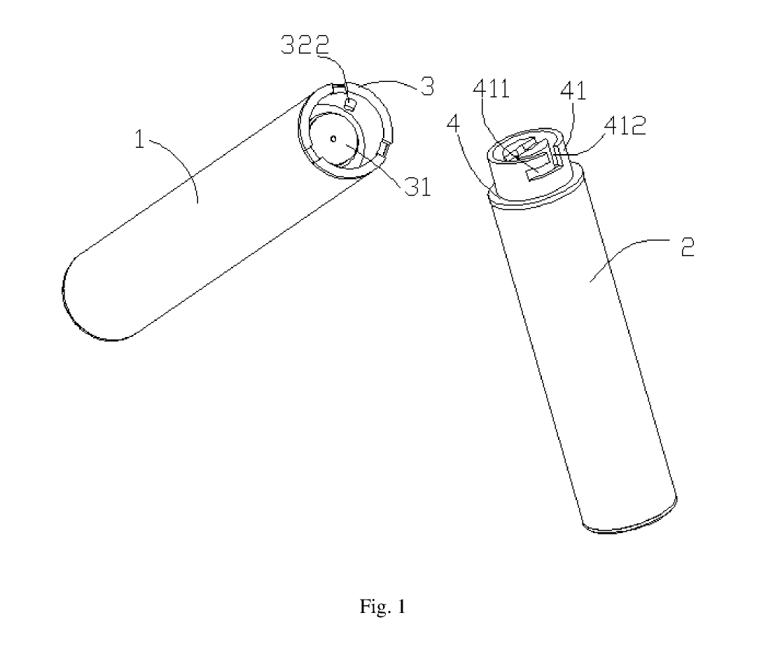

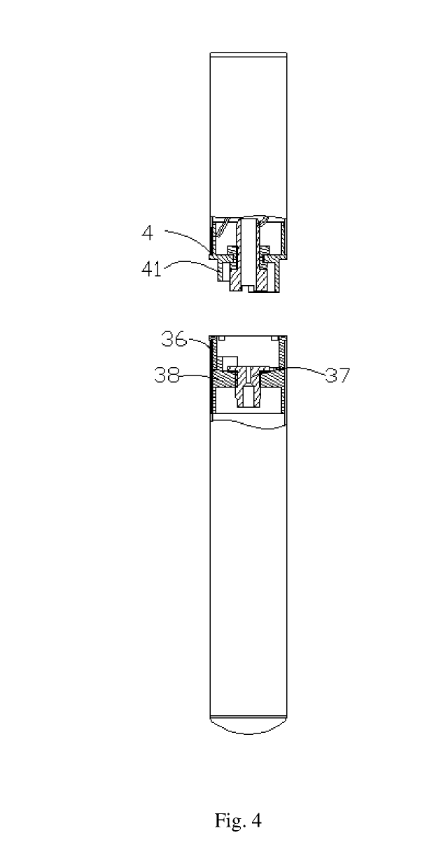

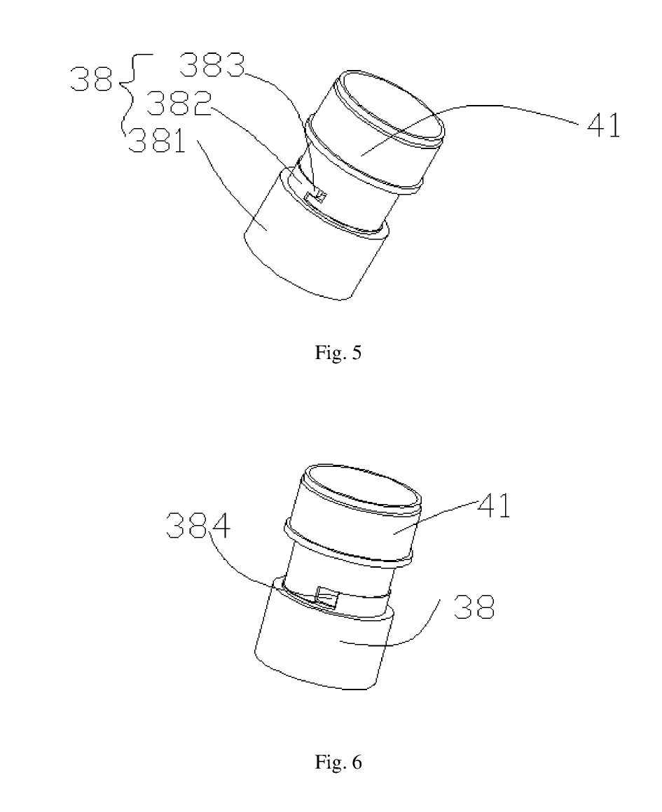

As shown in FIGS. 1 to 6, an electronic cigarette comprises an atomizer 1 and a battery rod 2. A connecting structure is provided at where the atomizer 1 and the battery rod 2 are connected. The connecting structure comprises a first connecting element 3 and a second connecting element 4 that are docked with each other. The first connecting element 3 is provided with a docking groove 31 used for insertion of the second connecting element 4. An engaging part is provided within the docking groove 31. An engaging-retaining notch extended to an end surface of the second connecting element 4 is provided at one end of the second connecting element 4 in proximity to the first connecting element 3. When engaged, the engaging part is inserted along the engaging-retaining notch and is rotated and hence engaged on the engaging-retaining notch.

Specifically, the engaging-retaining notch comprises a first notch 411 circumferentially defined on the second connecting element 4, and a second notch 412 axially extended from one end of the first notch 411 and open to the first connecting element 3. When engaged, the engaging part is inserted into the second connecting element 4 along the second notch 412, and is rotated along the first notch 411 to realize fixing connection between the engaging part and the second connecting element 4.

Generally, since the manufacture of the engaging-retaining notch is to define a notch on the second connecting element 4 only and the shape of the engaging part is variable, the engaging-retaining notch of a certain shape is adaptable to the engaging part of various shapes. In the present invention, the engaging-retaining notch is defined on the outside of the second connecting element 4, and the engaging part is defined on the inside of the first connecting element 3. Therefore, when the engaging-retaining notch is worn out, it is convenient to replace the component defined with the engaging-retaining notch, and it is also convenient to modify the shape of the notch to adapt to the engaging part with other shapes.

The second connecting element 4 comprises a first external electrode 41 defined at an outside of the second connecting element 4. The first and second notches 411 and 412 are defined on the first external electrode 41. The first and the second notches 411 and 412 together form an L-shaped structure. The first and the second notches 411 and 412 together may also form a T-shaped structure or a crisscross structure. The first and the second notches 411 and 412 together may also form other shapes, as long as they can engage with the engaging part. When engaged, in order to make the engaging part engage with the second notch 412 firmly, the engaging part and the outer wall of the second notch 412 are engaged via interference fit.

Two embodiments of the present invention are described in the following.

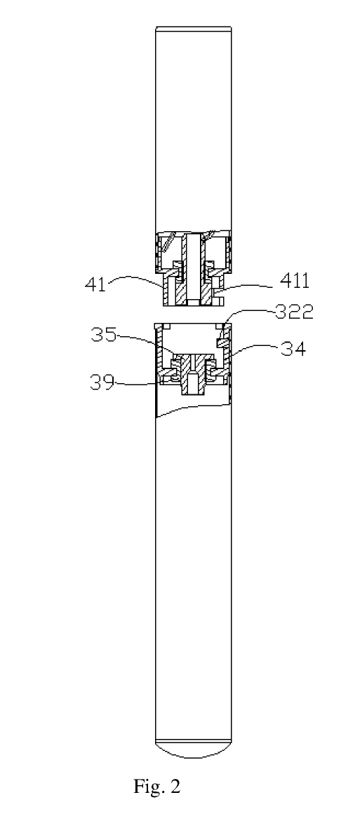

Embodiment 1: as shown in FIGS. 1 and 2, a second external electrode 34 that is hollow is defined on the first connecting element 3, and the engaging part is a protrusion radially extended from an inner wall of the second external electrode 34 along a direction toward a central axis of the second external electrode 34.

The engaging part may also be formed as follows: a second external electrode 34 that is hollow is defined on the first connecting element 3, a through hole for passing of a pin 322 is defined in a side wall of the second external electrode 34, and the pin 322 is inserted into the through hole via interference fit and is protruded toward a central axis of the second external electrode 34 to form the engaging part.

The engaging part may also be a flange that is extended from an inner wall and is capable of being engaged with the first notch 411. By engaging the flange with the first notch 411, the first connecting element 3 and the second connecting element 4 are connected.

Namely, the engaging part and the second external electrode 34 may be integrally formed or may be two separate components capable of being assembled with each other.

Preferably, in the present invention, the pin 322 is adopted.

When engaged, the first external electrode 41 and the second external electrode 34 need to be electrically connected together. Since both the second external electrode 34 and the firs external electrode 41 are of hollow structure, the first external electrode 41 is sheathed in the second external electrode 34 when engaged. The outer wall of the first external electrode 41 and the inner wall of the second external electrode are fitted to each other well to realize the electrical connection between the first and the second external electrodes 41 and 34.

A first internal electrode 35 is also sheathed in the second external electrode 34. In this case, in order to realize the insulation between the second external electrode 34 and the first internal electrode 35, an insulating ring 39 is sheathed in the second external electrode 34. The insulating ring 39 is arranged between the second external electrode 34 and the first internal electrode 35. The second external electrode 34 and the first internal electrode 35 are electrically connected to the anode and the cathode of the battery in the battery rod respectively.

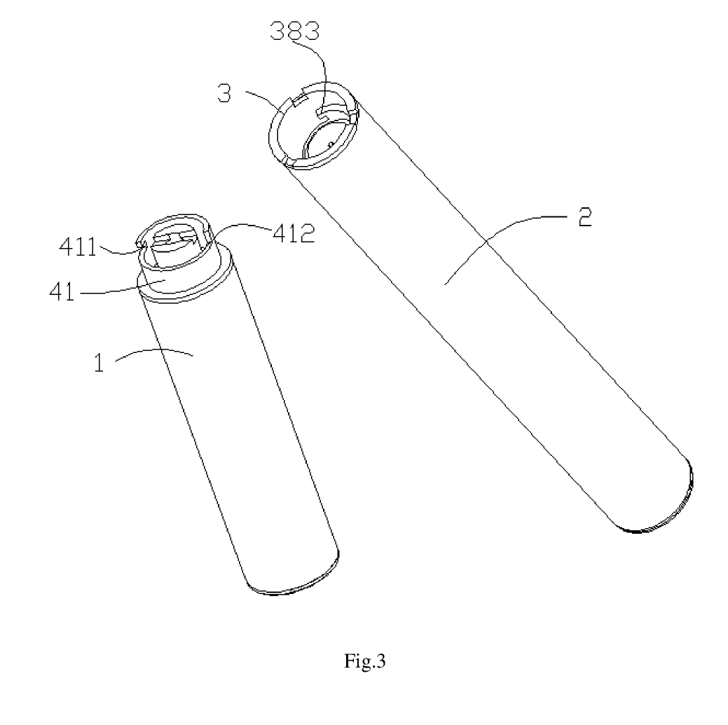

Embodiment 2: as shown in FIGS. 3-5, a third external electrode 36 is defined on the first connecting element 3, and a bracket 38 is defined at one side of the third external electrode 36 away from the second connecting element 4.

In order to electrically connect the first external electrode 41 with the third external electrode 36, the first and third external electrodes 41 and 36 are both cylindrical shaped. When engaged, the first external electrode 41 is sheathed in the third external electrode 36, and an outer wall of the first external electrode 41 and an inner wall of the third external electrode 36 are fitted each other well.

The bracket 38 is an insulator, a second internal electrode 37 is sheathed in the third external electrode 36, and the second internal electrode 37 is inserted into the bracket 38 via interference fit.

The bracket 38 is a rigid element. Specifically, the bracket 38 may be any one selected from the group consisting of rigid silicone element, rubber element and resin element.

Since the inside of the third external electrode 36 is required to be electrically insulated from the second internal electrode 37, the bracket 38 provided in one aspect can engage with the engaging-retaining notch by defining the engaging part on the bracket 38, and in another aspect can realize the electrical insulation between the third external electrode 36 and the second internal electrode 37.

Specifically, the bracket 38 comprises a bracket body 381 and a connecting portion 382 extended from the bracket body 381 toward the second connecting element 4. A side surface of an end portion of the connecting portion 382 is circumferentially extended to form a convex portion 383 coaxially arranged with the first notch 411 and shaped to fit the first notch 411. The engaging part is the convex portion 383. By inserting the connecting portion 382 into the third external electrode via interference fit, the bracket 38 is fixedly connected to the third external electrode 36.

The shape of the connecting portion 382 is adapted to the shape of the second notch 412, i.e. in order to make one end of the connecting portion abut against the bottom of the second notch 412, the axial length of the connecting portion 382 is the same as the axial length of the second notch 412. Preferably, the circumferential arc of the connecting portion 382 is the same as the arc of the second notch 412. On the basis of satisfying above conditions, it is understandable that the part of the first external electrode 41 that defines the first notch 411 and the second notch 412, the connecting portion 382 and the convex portion 383 together form an unchanged shape. When machining or numerical control machining, the first notch 411, the second notch 412, the connecting portion 382 and the convex portion 383 can be produced only by presetting a defined trail. Thus, it is convenient to be machined and facilitates mass production.

In the second embodiment, a first through hole 384 is formed between the connecting portion 382 and the second notch 412. Understandably, the first through hole is convenient to insert wire thereinto and to ventilate.

Understandably, the first connecting element 3 may defined on the atomizer 1 or may defined on the battery rod 2, and the second connecting element 4 may defined on the battery rod 2 or may defined on the atomizer 1.

To sum up, by providing the first and second connecting elements 3 and 4 that are rotating engaged, it facilitates manufacture. Meanwhile, by arranging the engaging-retaining notch at the outside of the second connecting element and arranging the engaging part within the first connecting element, it facilitates replacement of the second connecting element 4 with the engaging-retaining notch, and it facilitates modification to the shape of the engaging-retaining notch to adapt to other shape of the engaging part.

While the embodiments of the present invention are described with reference to the accompanying drawings above, the present invention is not limited to the above-mentioned specific implementations. In fact, the above-mentioned specific implementations are intended to be exemplary not to be limiting. In the inspiration of the present invention, those ordinary skills in the art can also make many modifications without breaking away from the subject of the present invention and the protection scope of the claims. All these modifications belong to the protection of the present invention.

1. An electronic cigarette, comprising an atomizer (1) and a battery rod (2); wherein a connecting structure is defined at where the atomizer (1) and the battery rod (2) are connected, and the connecting structure comprises a first connecting element (3) and a second connecting element (4) that are docked with each other; the first connecting element (3) is provided with a docking groove (31) used for insertion of the second connecting element (4); an engaging part is provided within the docking groove (31); an engaging-retaining notch extended to an end surface of the second connecting element (4) is provided at one end of the second connecting element (4), the end is in proximity to the first connecting element (3);
wherein the engaging-retaining notch comprises a first notch (411) circumferentially defined on the second connecting element (4), and a second notch (412) axially extended from one end of the first notch (411) and open to the first connecting element (3);
when engaged, the engaging part is inserted into the second connecting element (4) along the second notch (412), and is rotated along the first notch (411) to realize fixing connection between the engaging part and the second connecting element (4).

2. (canceled)

3. The electronic cigarette according to claim 1, wherein the second connecting element (4) comprises a first external electrode (41) defined at an outside of the second connecting element (4); and the first notch (411) and second notch (412) are defined on the first external electrode (41).

4. The electronic cigarette according to claim 3, wherein a second external electrode (34) that is hollow is defined on the first connecting element (3); and the engaging part is a protrusion radially extended from an inner wall of the second external electrode (34) along a direction toward a central axis of the second external electrode (34).

5. The electronic cigarette according to claim 3, wherein a second external electrode (34) that is hollow is defined on the first connecting element (3); a through hole for passing of a pin (322) is defined in a side wall of the second external electrode (34); and the pin (322) is inserted into the through hole via interference fit and is protruded toward a central axis of the second external electrode (34) to form the engaging part.

6. The electronic cigarette according to claim 4, wherein the first external electrode (41) is sheathed in the second external electrode (34), and an outer wall of the first external electrode (41) and an inner wall of the second external electrode (34) are fitted each other well.

7. The electronic cigarette according to claim 4, wherein a first internal electrode (35) and an insulating ring (39) are further sheathed in the second external electrode (34), and the insulating ring (39) is arranged between the second external electrode (34) and the first internal electrode (35).

8. The electronic cigarette according to claim 3, wherein a third external electrode (36) is defined on the first connecting element (3), and a bracket (38) is defined at one side of the third external electrode (36) away from the second connecting element (4).

9. The electronic cigarette according to claim 8, wherein the first external electrode (41) and the third external electrode (36) are both cylindrical shaped; when engaged, the first external electrode (41) is sheathed in the third external electrode (36), and an outer wall of the first external electrode (41) and an inner wall of the third external electrode (36) are fitted each other well.

10. The electronic cigarette according to claim 8, wherein the bracket (38) comprises a bracket body (381) and a connecting portion (382) extended from the bracket body (381) toward the second connecting element (4); a side surface of an end portion of the connecting portion (382) is circumferentially extended to form a convex portion (383) coaxially arranged with the first notch (411) and shaped to fit the first notch (411); and the engaging part is the convex portion (383).

11. The electronic cigarette according to claim 8, wherein the bracket (38) is an insulator, a second internal electrode (37) is sheathed in the third external electrode (36), and the second internal electrode (37) is inserted into the bracket (38) via interference fit.

12. The electronic cigarette according to claim 11, wherein the bracket (38) is any one selected from the group consisting of rigid silicone element, rubber element and resin element.

13. The electronic cigarette according to claim 10, wherein the shape of the connecting portion (382) is adapted to the shape of the second notch (412).

14. The electronic cigarette according to claim 1, wherein the first connecting element (3) is defined on the atomizer (1) or the battery rod (2), and the second connecting element (4) is defined on the battery rod (2) or the atomizer (1).

15. The electronic cigarette according to claim 1, wherein an L-shaped structure is formed by combination the first notch (411) and the second notch (412).

16. The electronic cigarette according to claim 1, wherein an T-shaped structure is formed by combination the first notch (411) and the second notch (412).
